(19) United States
(12) Patent Application Publication
(10) Pub. No.: US 2026/0288319 A1
(43) Pub. Date: Sep. 24, 2026

(54) INFORMATION PROCESSING APPARATUS, METHOD, AND STORAGE MEDIUM

(71) Applicant: CANON KABUSHIKI KAISHA, Tokyo (JP)

(72) Inventor: TAKAYUKI SUZUKI, Kanagawa (JP)

(21) Appl. No.: 19/560,385

(22) Filed: Mar. 9, 2026

(30) Foreign Application Priority Data
Mar. 19, 2025 (JP) 2025-045355

(51) Int. Cl. G06F 3/04845; G06F 3/0483; G06F 3/04883

(52) U.S. Cl. CPC G06F 3/04845; G06F 3/0483; G06F 3/04883

(57) ABSTRACT

The present disclosure provides an information processing apparatus including: a receiving unit configured to receive a gesture operation of an operator on a touch-panel display; and a display control unit configured to display data of contents including a plurality of pages on the touch-panel display on a page basis, an object capable of being moved by a gesture operation can be arranged on a page, and in a case where after the receiving unit receives a first operation of indicating to change a display page, a second operation that is a subsequent gesture operation is received in a first page that is a display page displayed based on the first operation before a predetermined time elapses since the first operation, the receiving unit recognizes the second operation as the first operation.

### BACKGROUND

### Field of the Technology

The present disclosure relates to control of a gesture operation in an information processing apparatus that controls a touch-panel display.

### Description of the Related Art

An application for an information processing apparatus provided with a touch-panel display receives a gesture operation with a finger of an operator or a stylus on the touch-panel display and performs processing corresponding to the operation.

In Patent Literature 1, a method of determining an operation event corresponding to a gesture operation on a touch panel is described. The touch-panel apparatus according to Japanese Patent Laid-Open No. 2014-170390 (Patent Literature 1) enters a gesture-waiting state in response to the first touch operation being performed in a state where no operation has been performed, and determines any subsequent gesture operation to be an operation event intended by the operator. In this way, any operation that is not intended by the operator is excluded from the touch-panel operation.

However, in order to improve usability, the determination of the operation on the touch-panel display and the operation event can be further improved.

### SUMMARY

The present disclosure provides an information processing apparatus comprising: a receiving unit configured to receive a gesture operation of an operator on a touch-panel display; and a display control unit configured to display data of contents including a plurality of pages on the touch-panel display on a page basis, wherein an object capable of being moved by a gesture operation is capable of being arranged on a page, and in a case where after the receiving unit receives a first operation of indicating to change a display page, a second operation that is a subsequent gesture operation is received in a first page that is a display page displayed based on the first operation before a predetermined time elapses since the first operation, the receiving unit recognizes the second operation as the first operation.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing a configuration of an information processing system;

FIG. 2 is a block diagram showing a configuration of an information processing apparatus;

FIG. 3 is a block diagram showing a configuration of a printing apparatus;

FIG. 4 is a block diagram showing a configuration of a server;

FIG. 5 is a block diagram showing a functional configuration of an editing app;

FIG. 6 is a diagram showing an example of a main screen of the editing app;

FIG. 7 is a diagram showing an example of a contents selection screen;

FIG. 8 is a diagram showing an example of a sheet size selection screen;

FIG. 9 is a diagram showing an example of an image selection screen;

FIG. 10 is a diagram showing an example of an editing screen;

FIG. 11 is a diagram showing an example of a print setting screen;

FIG. 12 is a flowchart showing an operation receiving process on the editing screen;

FIG. 13A and FIG. 13B show diagrams showing an example of operations and operation events on contents data;

FIG. 14A and FIG. 14B show diagrams for illustrating operation positions and operation directions of a first operation and a second operation;

FIG. 15 is a flowchart showing an operation receiving process according to a second embodiment; and

FIG. 16 is a flowchart showing an operation receiving process according to a third embodiment.

### DESCRIPTION OF THE EMBODIMENTS

In the following, embodiments of the present disclosure will be described in detail with reference to the accompanying drawings. Note that the embodiments described below are not intended to limit the scope of the claims, and all the combinations of the features described in the embodiments are not necessarily essential for the solution of the present disclosure.

Display data including a plurality of pages is sometimes displayed on a touch-panel display of a smartphone or the like. The operator can change (scroll) the display page to the subsequent page or the previous page by performing a swipe operation on the touch panel. However, in a case where the display data is data of contents being edited, an image object or the like is arranged in the display page in a movable manner. In this case, if the operator performs the swipe operation at the position where the object is arranged, the swipe operation is mistaken as a drag operation for the object, and the object is moved. The swipe operation and the drag operation are similar operations and both are operations involving the operator sliding a finger on the screen. In particular, there is a problem that the object may be unintentionally moved if the swipe operation is repeated in order to successively change pages. To cope with this problem, some editing application programs for contents having a plurality of pages prevent mistaking of the operation by providing a page change button in the editing screen. This leads to a restriction on the region where the page is displayed and thus to a problem from the viewpoint of screen design.

In view of this, in a first embodiment of the present disclosure, an operation receiving method will be described which is suitable for displaying data of contents including a plurality of pages in which an object capable of being moved by a gesture operation can be arranged in an information processing apparatus that controls a touch-panel display. In this embodiment, as an example, a case will be described in which an information processing apparatus having a touch-panel display, such as a smartphone or a tablet, executes an editing application program that performs editing or print setting of data of contents. In the following, the editing application program will be referred to as an editing app. Note that the operation receiving method according to the present disclosure is not limited to the editing app. The operation receiving method can be applied to various application programs and information processing apparatuses that can display data of contents including a plurality of pages on a touch-panel display and receive a gesture operation. Note that the touch-panel display does not necessarily have to be provided in the information processing apparatus, and may be connected to the information processing apparatus.

In this specification, data of contents is referred to as contents data. The contents include a document and a work including objects such as pictures (images) and texts laid out, for example. For example, the contents include a picture layout, a collage, a calendar, a card, a poster, a papercraft, a photo book, a brochure, a menu, a postcard, a leaflet (flyer), a banner flag, a business card, a shop card, an invitation, and a membership card, for example. The contents data will be described later.

The contents data is visualized by rendering processing. The image data is referred to as a contents image or contents. The contents image can be not only printed for use but also used as electronic contents in a website, SNS, or a virtual space, for example.

### First Embodiment

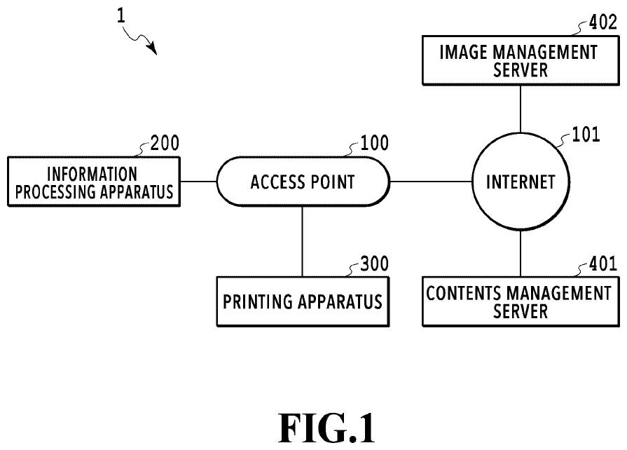

FIG. 1 is a diagram showing a configuration of an information processing system including an information processing apparatus according to a first embodiment. An information processing system 1 includes an information processing apparatus 200 and a printing apparatus 300. The information processing apparatus 200 and the printing apparatus 300 are communicatively connected to each other over a network formed by an access point 100. The information processing apparatus 200 and the printing apparatus 300 can access a contents management server 401 or an image management server 402 via an internet 101. Various programs including an editing app are installed in the information processing apparatus 200. The editing app at least has an editing function for contents data and a print setting function for contents data. Print data created from contents data using the editing app is transmitted from the information processing apparatus 200 to the printing apparatus 300 over the network.

The information processing apparatus 200 has a touch-panel display capable of receiving a gesture operation with a finger of an operator or a pointing device such as a stylus. The following embodiments will be described by taking a smartphone as an example of the information processing apparatus 200. However, the information processing apparatus is not limited to the smartphone as long as the information processing apparatus can receive a gesture operation via a touch-panel display. For example, the present disclosure can be applied to various apparatuses, such as portable terminals other than smartphones, notebook personal computers (PCs), desktop PCs, tablet terminals, personal digital assistants (PDAs), and digital cameras.

The printing apparatus 300 is a printer having a printing function for printing on a recording medium (referred to as a sheet, hereinafter) and may be an ink jet printer or a laser beam printer, for example. Furthermore, the printing apparatus 300 may be a multifunction peripheral (MFP) having not only a printing function but also a scanning function for reading an original, a copying function and a facsimile function. Note that the printing method of the printing apparatus 300 is not limited to the ink jet method and the electrophotographic method, and the present disclosure can be applied to printing apparatuses of other various printing methods, such as the thermal sublimation method.

The editing app is a computer-readable program and is downloaded and installed from an application distribution server (not shown), for example, to the information processing apparatus 200 over the network. Alternatively, the editing app may be stored in a storage medium and read and installed in the information processing apparatus 200. Furthermore, the editing app may be a Web app that runs on a browser of the information processing apparatus 200 in cooperation with a server via the Web and can be in any form. The information processing apparatus 200 may request the server to perform a part of processing of the editing app and obtain data of the processing result from the server. The editing app will be described later.

The access point 100 functions as a wireless LAN router. Via the wireless LAN router, the information processing apparatus 200 is connected to the internet 101. Therefore, the information processing apparatus 200 can communicate with the contents management server 401, the image management server 402, a storage server and other servers via the internet. Note that although FIG. 1 shows one information processing apparatus 200, one printing apparatus 300, one contents management server 401 and one image management server 402, there may be a plurality of each of these components.

The contents management server 401 is a server that stores and manages contents data created and edited by the editing app. The contents data may be template data previously prepared or contents data generated by editing template data. Alternatively, the contents data may be contents data newly created and edited by an operator. Alternatively, the contents data may be contents data automatically generated by a generative AI. The contents data will be described later.

The image management server 402 is a server that can save image data or stock image data obtained with a camera by a user of the information processing system 1. In a case where the editing app edits contents data, image data arranged in a page can be downloaded and used from the image management server 402. Note that the contents management server 401 and the image management server 402 are a server system, which may be formed by one server computer or a plurality of server computers. In other words, the processing performed by each server described above may be performed by one server computer or may be performed by a plurality of server computers in cooperation.

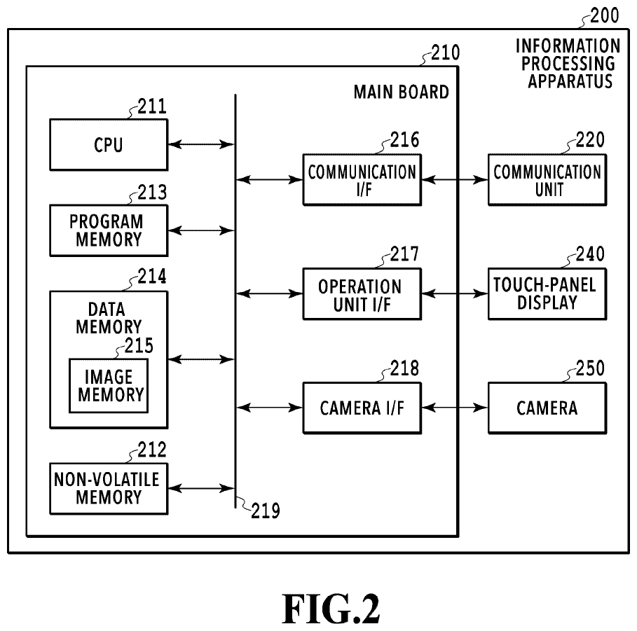

FIG. 2 is a block diagram showing a configuration of the information processing apparatus 200 according to this embodiment. FIG. 2 shows an internal configuration of a smartphone, which is an example of the information processing apparatus 200. As shown in FIG. 2, the information processing apparatus 200 has a main board 210, a communication unit 220, a touch-panel display 240 and a camera 250.

On the main board 210, a CPU 211 in the form of a microprocessor, a program memory 213 in the form of a ROM, a data memory 214 in the form of a RAM and a non-volatile memory 212 are disposed.

The CPU 211 is a control circuit for controlling the whole of the apparatus. The CPU 211 operates according to a control program stored in the program memory 213 to which the CPU 211 is connected via an internal bus 219 and data stored in the data memory 214. The program memory 213 stores an operating system (OS), the editing app according to this embodiment and other application programs. In this embodiment, each application program stored in the program memory 213 is subjected to software execution control under the control of the OS. Specifically, the CPU 211 executes an application program stored in the program memory 213 by loading the application program into the data memory 214 (RAM). In this way, each processing described in the application program in the form of a program code is performed. That is, a function included in the editing app described later is served by the CPU 211 performing processing according to an application program.

On the main board 210, a communication interface (I/F) 216, an operation unit interface (I/F) 217 and a camera interface (I/F) 218 are disposed. The communication I/F 216 includes a wireless LAN control circuit, an NFC control circuit and a line control circuit, for example, which are connected to a wireless LAN unit, an NFC unit and a line connection unit in the communication unit 220, respectively. The communication unit 220 may include a unit for implementing a communication method of Bluetooth (registered trademark) Low Energy (BLE).

The CPU 211 performs communication with another apparatus over a wireless LAN by controlling the wireless LAN unit via the wireless LAN control circuit. Note that the wireless LAN unit is capable of data (packet) communication in a communication method in conformity with the IEEE 802.11 series (IEEE 802.11a, IEEE 802.11b, IEEE 802.11g and the like), for example. Furthermore, the CPU 211 can detect a connection by NFC with another NFC terminal and transmit/receive data to/from the other NFC terminal by controlling the NFC unit via the NFC control circuit. Furthermore, the CPU 211 can connect to a cellular phone line network and make a call or perform data transmission/reception by controlling the line connection unit via the line control circuit.

The CPU 211 performs display control and operation control on the touch-panel display 240 via the operation unit I/F 217. The touch-panel display 240 has a display and a touch panel provided on a screen of the display. The touch-panel display 240 displays display data output from the CPU 211. For example, the CPU 211 displays a user interface (UI) screen for the editing app on the touch-panel display 240. The UI screen for the editing app will be described later. Furthermore, the CPU 211 receives a gesture operation from the operator on the touch-panel display 240.

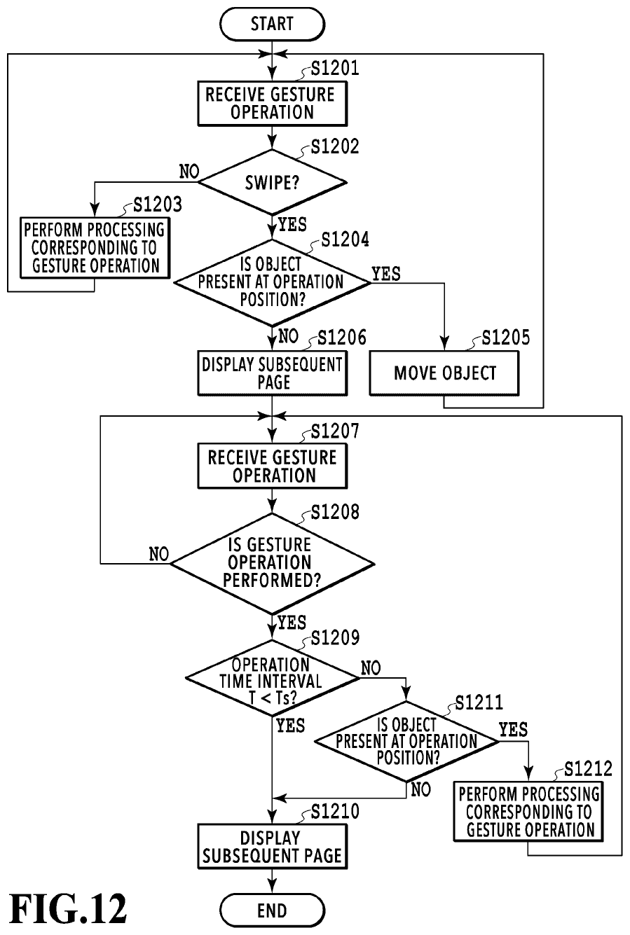

The touch panel of the touch-panel display 240 includes a detector for detecting a touch position of a finger of the operator or the like. The detector inputs, to the CPU 211, an operation signal including a position of a touch-on, which is an operation of touching the screen with a finger, a position of a touch-off, which is an operation of removing the finger from the screen, and a locus (direction and moving distance) along which the finger is moved. The position of a touch-on is the starting point of a gesture operation. The position of a touch-off is the end point of a gesture operation. The CPU 211 receives the operation signal from the detector and performs operation receiving processing for determining the content of the gesture operation based on the operation signal, the point in time at which the operation signal is received and an object displayed at the operation position. The operation receiving processing includes operation receiving processing (FIG. 12) described later. The CPU 211 functions as an operation receiving unit 503 of the editing app described later by performing the operation receiving processing according to a program. The gesture operation and the operation receiving processing will be described later.

The display control on the touch-panel display 240 is implemented by the CPU 211 performing display control processing according to a display control program. The CPU 211 functions as a display control unit 504 of the editing app described later by performing the display control processing.

Note that the information processing apparatus 200 may have various operation buttons, such as a power supply button, a sound volume button and an enter button as operation units in addition to the touch-panel display 240. A pressing signal from the operation button is also input to the CPU 211 from the operation unit I/F 217.

The CPU 211 controls the camera 250 via the camera I/F 218. The camera 250 takes an image including a still image and a moving image. The image taken by the camera 250 is stored in an image memory 215 in the data memory 214 under the control of the CPU 211. Note that the CPU 211 can store, in the image memory 215, not only the images taken by the camera 250 but also an image obtained from an external apparatus via the communication unit 220. Furthermore, the CPU 211 can transmit an image stored in the image memory 215 to an external apparatus, such as the image management server 402, via the communication unit 220. The external apparatus may be the image management server 402 or a server of a storage service or a server of an SNS, for example.

The non-volatile memory 212 is a non-volatile storage apparatus, such as a flash memory, and stores data that needs to be retained even after the power supply is turned off. For example, the non-volatile memory 212 stores contact list data, various types of communication information, information about devices to which the information processing apparatus 200 connected in the past, and image data that needs to be saved, for example. Various types of setting information used by the editing app according to this embodiment are also stored in the non-volatile memory 212.

Note that the configuration of the information processing apparatus 200 is not limited to the configuration shown in FIG. 2. The configuration shown in FIG. 2 can be modified as required and may include a sound processing circuit, a microphone, a speaker, a GPS for position detection, or various types of sensors, for example.

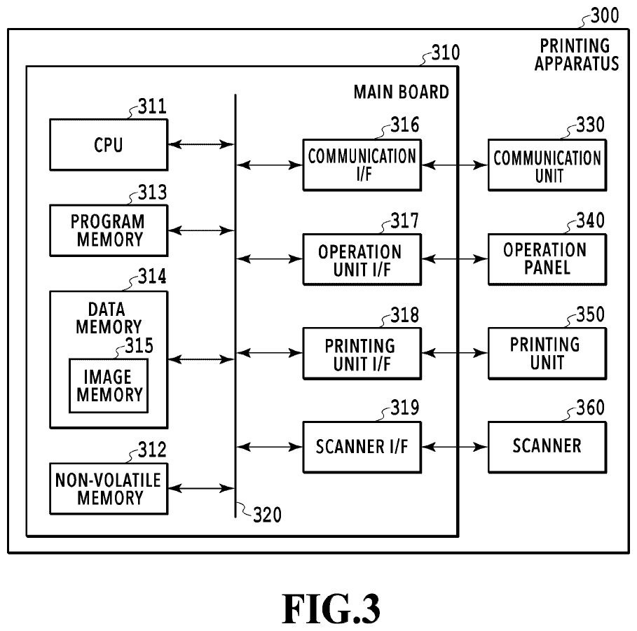

FIG. 3 is a block diagram showing a configuration of the printing apparatus 300. FIG. 3 shows an internal configuration of a printer having a printing function and a scanning function as an example of the printing apparatus 300. As shown in FIG. 3, the printing apparatus 300 has a main board 310, a communication unit 330, an operation panel 340, a printing unit 350 and a scanner 360.

On the main board 310, a CPU 311 in the form of a microprocessor, a program memory 313 in the form of a ROM, a data memory 314 in the form of a RAM and a non-volatile memory 312 are disposed.

The CPU 311 is a control circuit for controlling the whole of the apparatus. The CPU 311 operates according to a control program stored in the program memory 313 to which the CPU 311 is connected via an internal bus 320 and data stored in the data memory 314. The program memory 313 stores an embedded OS and an application program. In this embodiment, each application program stored in the program memory 313 is subjected to software execution control under the control of the OS. The CPU 311 executes a program stored in the program memory 313 by loading the program into the data memory 314 (RAM).

On the main board 210, furthermore, a communication I/F 316, an operation unit I/F 317, a printing unit I/F 318 and a scanner I/F 319 are disposed. The communication I/F 316 includes a wireless LAN control circuit and an NFC control circuit, for example, which are connected to a wireless LAN unit and an NFC unit in the communication unit 330, respectively. The communication unit 330 may include a unit for implementing a communication method of Bluetooth (registered trademark) Low Energy (BLE).

The CPU 311 performs communication with another apparatus over a wireless LAN by controlling the wireless LAN unit via the wireless LAN control circuit. Furthermore, the CPU 311 can detect a connection by NFC with another NFC terminal and transmit/receive data to/from the other NFC terminal by controlling the NFC unit via the NFC control circuit. For example, the CPU 311 stores print data received from the information processing apparatus 200 via the communication unit 330 in the data memory 314. The print data is transmitted from the information processing apparatus 200 as a print job including image data and print setting information.

The CPU 311 performs display control and operation control on the operation panel 340 via the operation unit I/F 317. The operation panel 340 includes a touch-panel display, a numeric keypad and various types of operation buttons. The operation panel 340 displays display data output from the CPU 311. For example, the operation panel 340 displays a status of the printing apparatus 300, a function selection menu, print setting information, and information about sheets and inks. The CPU 311 receives an operation from the operator on the operation panel 340 via the operation unit I/F 317.

The CPU 311 controls the scanner 360 via the scanner I/F 319. The scanner 360 reads an original set in the printing apparatus 300 and stores the read data in the image memory 315 in the data memory 314. The CPU 311 can transmit the scanned image data to the information processing apparatus 200 via the communication I/F 316 and the communication unit 330.

The printing unit 350 can print by receiving a print job including data in the JPEG file format, for example, assigned a printer control instruction. The CPU 311 performs printing processing by controlling the printing unit 350 via the printing unit I/F 318. In the printing processing, the printing unit 350 prints image data stored in the image memory 315 in the data memory 314 on a sheet. The image data printed by the printing unit 350 includes image data of contents data edited by the information processing apparatus 200 and data read by the scanner 360, for example.

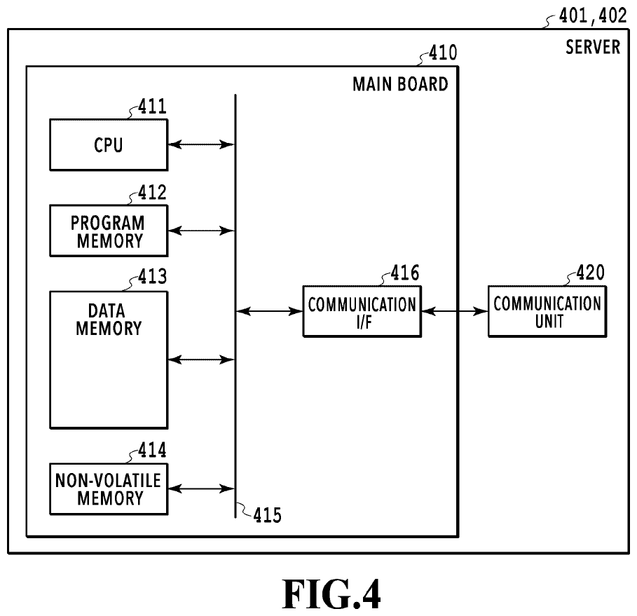

FIG. 4 is a block diagram showing a configuration of a computer that functions as the contents management server 401 and the image management server 402 according to this embodiment. As shown in FIG. 4, each server has a main board 410 and a communication unit 420. The communication unit 420 includes a wireless LAN unit and a line connection unit, which are capable of communication using a wireless LAN and a cellular phone line network, respectively.

On the main board 410, a CPU 411 in the form of a microprocessor, a program memory 412 in the form of a ROM, a data memory 413 in the form of a RAM, a non-volatile memory 414 and a communication I/F 416 are disposed. A communication unit 420 is connected to the communication I/F 416.

The CPU 411 operates according to a control program stored in the program memory 412 to which the CPU 411 is connected via an internal bus 415 and data stored in the data memory 413. The program memory 412 stores an OS and a program, such as an application program. In this embodiment, each application program is subjected to software execution control under the control of the OS. Specifically, the CPU 411 executes an application program stored in the program memory 412 by loading the application program into the data memory 413 (RAM). In this way, each processing described in the application program in the form of a program code is performed. That is, a function included in an application program is served by the CPU 411 performing processing according to the application program.

The CPU 411 performs communication with another apparatus over a wireless LAN by controlling the wireless LAN unit via the wireless LAN control circuit. Furthermore, the CPU 411 can connect to a cellular phone line network and make a call or perform data transmission/reception by controlling the line connection unit via the line control circuit.

The non-volatile memory 414 is a non-volatile storage apparatus, such as a flash memory, and stores data that needs to be retained even after the power supply is turned off. For example, with the contents management server 401, the non-volatile memory 414 stores contents data. With the image management server 402, the non-volatile memory 414 stores image data. Furthermore, the non-volatile memory 414 may store user information on a user of the system or information required for data management, for example.

Note that the contents management server 401 and the image management server 402 do not have to have the same configuration. The servers are not limited to the configuration shown in FIG. 4 and may have an operation unit, a display unit or other components as required.

### (Editing App)

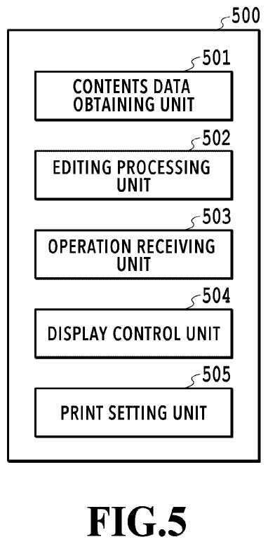

FIG. 5 is a block diagram showing a functional configuration of an editing app 500. The editing app 500 is an application program that is installed in the information processing apparatus 200 and includes a program for making the information processing apparatus 200 perform editing processing on data of contents. As shown in FIG. 5, the editing app 500 has a contents data obtaining unit 501, an editing processing unit 502, an operation receiving unit 503, a display control unit 504 and a print setting unit 505.

The contents data obtaining unit 501 obtains contents data to be processed by the editing app. The contents data may be template data previously prepared or contents data generated by editing template data. Alternatively, the contents data may be contents data newly created and edited by an operator. Alternatively, the contents data may be contents data automatically generated by a generative AI. The contents data may be formed by one page or include a plurality of pages. In each page, one or more objects are arranged on an image plane of a predetermined size. Each page has a plurality of layers, for example. A background object is arranged at the lowermost layer, and objects can be arranged at higher layers (layers forming a foreground) in an overlaid manner. Objects arranged in a page include various types of objects including image objects, such as pictures and stamps, text objects, and graphic objects. Note that in this embodiment, objects that can be moved by gesture operations are objects arranged at the most frontward (foreground) layer at the operation position. Furthermore, image objects and text objects arranged at a particular layer, such as background objects, and pages themselves are not allowed to be moved. The contents data obtaining unit 501 displays a screen on which contents can be selected, such as a contents selection screen described later, and receives an operation of searching for or selecting contents data from a user. The contents data can be obtained from the non-volatile memory 212 or the contents management server 401 of the information processing apparatus 200 or other external apparatus. The contents data obtaining unit 501 retains the obtained contents data in the image memory 215 in the data memory 214.

The editing processing unit 502 performs processing, such as creation of new contents data and editing and saving of contents data obtained by the contents data obtaining unit 501, according to an operation received by the operation receiving unit 503. The editing processing unit 502 displays an editing screen, which is an UI screen, on the touch-panel display 240, displays contents data to be processed on the editing screen, and receives an operation on the contents data from the user. Furthermore, the editing processing unit 502 performs processing according to an operation. The processing result is reflected in the contents data displayed on the editing screen.

The operation receiving unit 503 receives a gesture operation on the touch-panel display 240 from the operator.

### (Gesture Operation)

Next, the gesture operation will be described. In this specification, the gesture operation is an operation on the touch-panel display 240 with a finger of the operator or a pointing device such as a stylus. The gesture operations include a tap operation, a swipe operation and a drag operation, for example. The tap operation is an operation of touching the touch-panel display 240 with a finger or the like and immediately moving the finger off the touch-panel display 240. In addition to a single tap operation, there is a double-tap operation, in which two taps occur repeatedly. A tap and hold operation is an operation of touching the touch-panel display 240 with a finger or the like (touch-on), keeping the contact at the position for a predetermined time or longer and then moving the finger off the touch-panel display 240 (touch-off). The swipe operation is an operation performed in a case of scrolling a screen, such as changing pages, and is an operation of sliding the finger on the touch-panel display 240 in an arbitrary direction and then moving the finger off the touch-panel display 240. The drag operation is an operation performed in a case of moving an object on the screen and is an operation of touching an object on the touch-panel display 240 with a finger and sliding the finger in an arbitrary direction while the finger is in contact with the object. Note that there is a flick operation, which is similar to the swipe operation and the drag operation. The flick operation is an operation of touching the touch-panel display 240 with a finger and then quickly sliding the finger in an arbitrary direction. The flick operation is an operation in which the moving distance of the finger on the screen is shorter than in the swipe operation. The flick operation is used for operating a software keyboard, for example. Furthermore, the gesture operations described above may be performed with two or more fingers, rather than one finger. In that case, these gesture operations are differentiated.

An operation signal responsive to the gesture operation is input to the operation receiving unit 503 (CPU 211) from the touch panel. The operation receiving unit 503 (CPU 211) receives the operation signal from the touch panel, and determines the content of the gesture operation based on the operation signal, the point in time at which the operation signal is received and the object displayed at the operation position. Note that although the operation position is the starting position (touch-on position) of the gesture operation in this description, this is not intended to be limiting. For example, the operation position may be the end position (touch-off position) of the gesture operation or all positions (locus) passed through from the touch-on to the touch-off. Alternatively, the operation position may be a representative position included in the locus.

In this embodiment, in a state where data of contents including a plurality of pages is displayed on the touch-panel display 240 on a page basis, the operation receiving unit 503 receives an operation as described below. Note that in a page, an object that can be moved by a gesture operation can be arranged. After receiving a first operation of indicating to change pages, on a first page, which is a display page displayed based on the first operation, the operation receiving unit 503 receives a second operation, which is a next gesture operation, before a predetermined time Ts elapses since the first operation. In a case where the operation time interval is short as in this case, the operation receiving unit 503 receives the second operation as the first operation (an operation of indicating to change display page). Note that the first operation is preferably the swipe operation, which is common as an operation of indicating to change display page. However, the first operation is not necessarily limited to the swipe operation. For example, an operation differentiated from the swipe operation with one finger, such as the swipe operation with two fingers, may be assigned. Thus, in a case where the next gesture operation (second operation) is performed immediately after the first swipe operation (first operation), the operation is recognized as the swipe operation (first operation), regardless of what type of operation the second operation is. As a result, even if there is an object that can be moved at the operation position, the object is not moved, and the page is changed. Therefore, the operability in successive page changes is improved.

Note that in a case where after receiving the first operation, the operation receiving unit 503 receives the second operation after the predetermined time Ts elapses since the first operation on the first page displayed based on the first operation, the operation described above does not occur. In a case where the operation time interval is long as in this case, if the second operation is a swipe operation on an object arranged in the displayed page, the operation receiving unit 503 receives the second operation as an operation for moving the object. Note that the second operation in this case is also referred to as the drag operation.

In a case where the operation time interval is long, furthermore, if the second operation is an operation on an object arranged in the displayed page or an outside object displayed outside the page, the operation receiving unit 503 receives the second operation as an operation on the object. For example, if the second operation is a tap operation on an object in the page, the second operation is received as an operation of selecting or indicating the object. Furthermore, for example, if the second operation is a tap operation on a button that is an outside object, the second operation is received as an operation of pressing down the button.

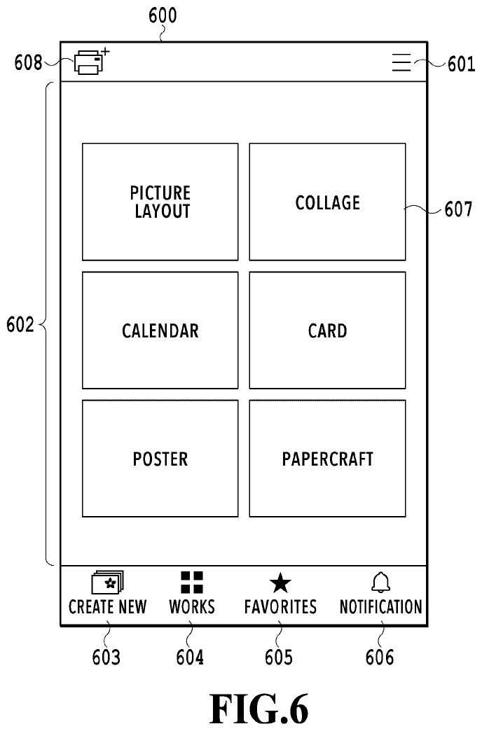

The display control unit 504 displays various screens as a user interface screen for the editing app. The various screens for the editing app will be described later (FIGS. 6 to 11). The display control unit 504 displays an editing screen as a user interface screen for the editing app, and displays contents data obtained by the contents data obtaining unit 501 in an editing region in the editing screen. In a case where the contents data includes a plurality of pages, the display control unit 504 displays the contents data on a page basis. Furthermore, the display control unit 504 reflects the result of processing performed according to the operation in the contents data displayed on the editing screen. For example, the display control unit 504 changes the page displayed on the editing screen in response to a swipe operation. In a case of changing the display page, in this embodiment, the page is changed by being scrolled (moved) in the left-and-right direction, for example. However, the direction is not limited to the left-and-right direction, and the display page may be changed by being scrolled (moved) in the up-and-down direction.

In a case where the operation receiving unit 503 receives the first operation described above (an operation of indicating to change the display page) in a state where a page is displayed, the display control unit 504 changes the display page to a first page and displays the first page. Furthermore, in a case where the operation receiving unit 503 receives the second operation as the first operation in a state where the first page is displayed, the display control unit 504 changes the display page from the first page to a second page, which is different from the first page.

In a case where the first operation and the second operation occur in the same direction, that is, in a case where the angle between the operation direction of the first operation and the operation direction of the second operation is equal to or less than a predetermined angle (01 or less), the display control unit 504 displays the page subsequent to the first page as the second page. For example, it is assumed that the pages are arranged in the order of a page n−1, a page n, a page n+1 and a page n+2. In this case, in a case where the page displayed first is the page n, and the page n+1 is displayed in the first operation, the page n+1 is displayed in the second operation. In a case where the page displayed first is the page n, and the page n−1 is displayed in the first operation, the page n−1 is displayed in the second operation.

In a case where the first operation and the second operation occur in the opposite directions, that is, in a case where the angle between the operation direction of the first operation and the operation direction of the second operation is greater than a predetermined angle θ2, the display control unit 504 displays the page preceding the first page as the second page. For example, it is assumed that the pages are arranged in the order of the page n−1, the page n and the page n+1. In this case, in a case where the page displayed first is the page n, and the page n+1 is displayed in the first operation, the page n is displayed again in the second operation. In a case where the page displayed first is the page n, and the page n−1 is displayed in the first operation, the page n is displayed again in the second operation.

The print setting unit 505 receives a setting about the printing of the contents data from the operator and generates print setting information. In a case where a print execution instruction is input by the user, the CPU 211 generates a print job including data of a contents image obtained by rendering contents data and print setting information, and transmits the print job to the printing apparatus 300.

Next, with reference to FIGS. 6 to 11, UI screens for the editing app and operations on the screens will be described. The screens shown in FIGS. 6 to 11 are displayed on the touch-panel display 240 in response to the CPU 211 of the information processing apparatus 200 executing the editing app stored in the program memory 213. The following description will be made on the assumption that the UI control for the editing app in this embodiment is created in a program language that operates on a multi-platform, such as HTML5 or JavaScript. However, this is not intended to be limiting, the editing app may be created in a platform-dependent language, such as Java or Objective-C.

Note that processing performed by the editing app in a state where each UI screen shown below is displayed is implemented by the CPU 211 executing a program of the editing app stored in the program memory 213 or the like by loading the program into the data memory 214, which is a RAM. Note that all processing described below is not necessarily sequentially performed in one process. For example, there may be a case where the responsibility of processing is once transferred to the OS, the OS invokes the editing app again, and then the editing app performs the subsequent processing.

The editing app is activated in a case where an icon corresponding to the editing app is selected by a touch operation on a home screen displayed on the touch-panel display 240 of the information processing apparatus 200. The home screen is a so-called standby screen displayed by processing by the OS of the information processing apparatus 200. In the home screen, one or more icons corresponding to various application programs installed in the information processing apparatus 200 are displayed. In a case where each icon is selected by operation from the operator, the application program corresponding to the selected icon is activated. In a case where the editing app is activated, a main screen 600 for the editing app is displayed.

FIG. 6 is a diagram showing the main screen 600 for the editing app. In the main screen 600, a menu button 601, a main display region 602, a create new button 603, a works button 604, a favorite button 605, a notification button 606 and a printer registration button 608 are displayed, for example.

In a case where any button is tapped by the operator, a display content corresponding to the tapped button is displayed in the main display region 602. FIG. 6 shows an example display in the main display region 602 at the time of activation of the editing app or in a case where the create new button 603 for creating new print data is tapped.

In a case where the printer registration button 608 is tapped, a printer registration screen (not shown) is displayed. In registration processing on the printer registration screen, the printer (printing apparatus 300) that is the transmission destination of the print job is selected and set. In a case where the menu button 601 is tapped, various sorts of information, such as version information and license information, are displayed.

In the main screen 600 shown in FIG. 6, a plurality of category selection buttons 607 are displayed in the main display region 602. Each of the category selection buttons 607 corresponds to a category of works (contents) that can be created with the editing app. In FIG. 6, “picture layout”, “collage”, “calendar”, “card”, “poster” and “papercraft” are displayed as the category selection buttons 607, for example. Note that although each category selection button 607 is displayed in the form of a text in the example in FIG. 6, an icon corresponding to each category may be displayed in addition to the text.

In a case where any of the category selection buttons 607 is tapped by the operator, the display control unit 504 transitions to a screen for printing or editing contents data of the category corresponding to the tapped category selection button 607. Specifically, for example, in a case where the category selection button 607 indicating “papercraft” is tapped, the display control unit 504 displays a screen for printing or editing a papercraft on the touch-panel display 240. Similarly, in a case where the category selection button 607 indicating “calendar” is tapped, the display control unit 504 displays a screen for printing or editing a calendar on the touch-panel display 240.

Note that the contents data may be image data itself as described above or may be data of a template for arranging image data or text data. Although the contents data is obtained from the contents management server 401 in this embodiment, contents data previously retained by the editing app may also be used. Furthermore, the contents data that can be used for printing and the presence or absence of an editing function, such as image or text insertion to contents data, vary with the category selection button 607 tapped by the operator.

On the main screen 600 shown in FIG. 6, in a case where the works button 604 is tapped, the display control unit 504 displays a list of thumbnails of works saved by the operator in the form of icons in the main display region 602. The works saved by the operator mean contents data created by the operator using the editing app. Note that in the displayed list of works, the thumbnails of the works displayed may be sorted based on the categories corresponding to the category selection buttons 607.

In a case where the favorite button 605 is tapped, a screen for showing a list of contents data registered to favorites by the operator in the main display region 602. In a case where the notification button 606 is tapped, notification information, such as a notification of data update in the contents management server 401 or the image management server 402, is displayed in the main display region 602.

Next, example displays in cases where the category selection buttons 607 are tapped will be described. In a case where any of the category selection buttons 607 is tapped, the screen transitions to a contents selection screen 700 for displaying a list of contents data corresponding to the selected category.

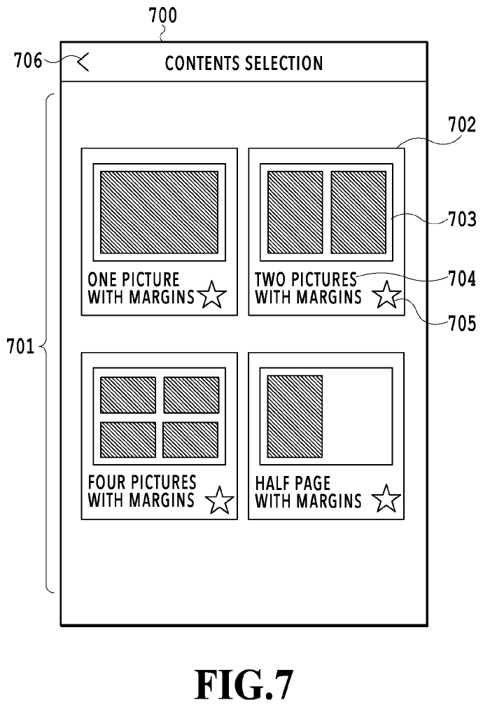

FIG. 7 is a diagram showing the contents selection screen 700 to which the screen transitions in a case where the “picture layout” among the category selection buttons 607 is tapped. The contents selection screen 700 includes a return button 706 and a contents display region 701. In a case where the return button 706 is tapped, the screen transitions to the screen (the main screen 600 shown in FIG. 6) displayed before the transition to this screen. In the contents display region 701, a plurality of items of contents information 702 are displayed in a selectable manner. The contents information 702 includes a thumbnail 703 of contents data corresponding to each category, a contents name 704 and a favorite button 705. In the example shown in FIG. 7, some items of template information are displayed as the contents information 702. In a case where the favorite button 705 is tapped, corresponding contents data is registered to the favorites. The contents data registered to the favorites is displayed on a favorite screen in response to the favorite button 605 (FIG. 6) described later being tapped. In a case where the contents information 702 is tapped, the screen transitions to a sheet size selection screen.

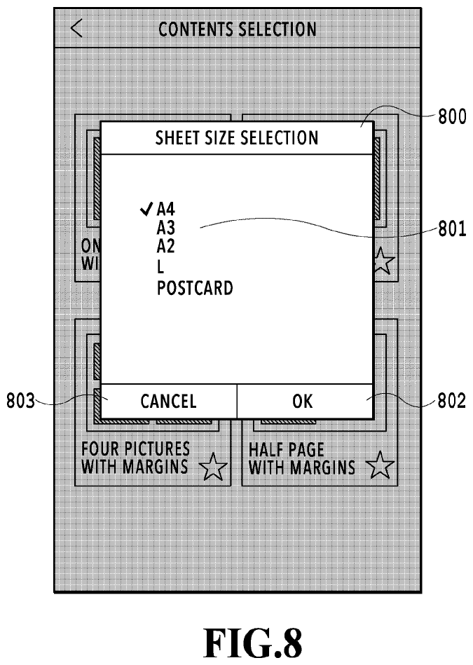

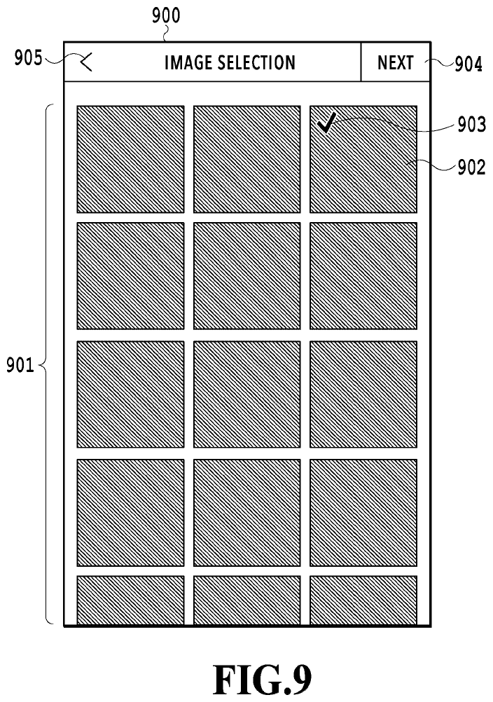

FIG. 8 is a diagram showing an example display of a sheet size selection screen 800. The sheet size selection screen 800 includes a sheet size list 801, an OK button 802 and a cancel button 803. The operator can specify the size of the sheet used for printing from among the sheet sizes displayed in the sheet size list 801. In a case where the cancel button 803 is tapped, the display control unit 504 transitions to the screen (the contents selection screen 700 shown in FIG. 7) before the transition to this screen. In a case where the OK button 802 is tapped, the contents data obtaining unit 501 obtains the contents data selected by the operator on the contents selection screen 700. Furthermore, the contents data obtaining unit 501 obtains image data that can be used for the contents data. The display control unit 504 displays an image selection screen 900 for displaying the obtained image data shown in FIG. 9 on the touch-panel display 240.

In a case where the image data that can be used for the selected contents data is stored in the contents management server 401 or the image management server 402, the contents data obtaining unit 501 downloads the image data from the contents management server 401 or the image management server 402. In a case where the image data that can be used for the selected contents data is previously retained in the editing app, the contents data obtaining unit 501 does not perform downloading from the server but obtains the previously retained image data. The image data obtained here may include print setting information indicating an optimal print setting for printing. The display control unit 504 of the editing app displays an image selection screen including the obtained image.

Note that the obtaining and displaying of the contents data and the image data are not limited to this method. The editing app may download image data corresponding to the contents from the contents management server 401 or the like before the sheet size selection screen is displayed or while the sheet size selection screen is displayed, in response to the selection operation for the contents on the contents selection screen.

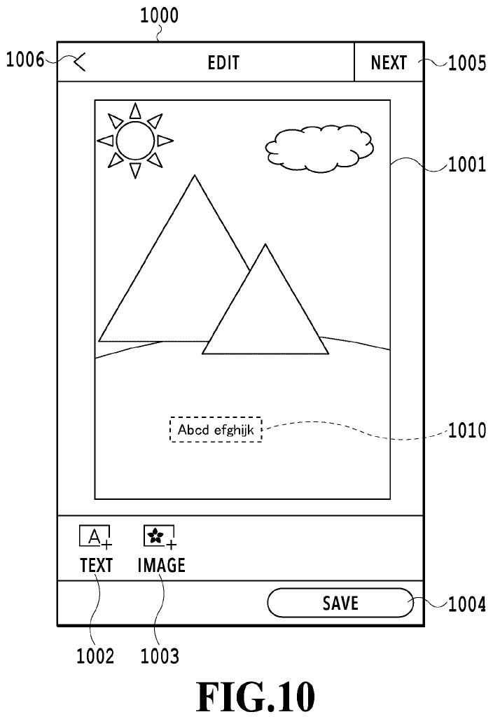

FIG. 9 is a diagram showing an image selection screen 900. The image selection screen 900 includes a return button 905, an image thumbnail display region 901 and a next button 904. In a case where the return button 905 is tapped, the display control unit 504 makes the display on the touch-panel display 240 transition to the contents selection screen 700 shown in FIG. 7. In the image thumbnail display region 901, an image retained in the information processing apparatus 200 or an image retained in the image management server 402 is displayed in the form of a thumbnail 902. In a case where one or more thumbnails 902 are selected by the operator, image data corresponding to the selected thumbnail(s) can be arranged on the contents data (template) selected on the contents selection screen 700. The display control unit 504 displays a selected state icon 903 that allows the thumbnail 902 to be discerned as having been selected on the thumbnail 902 selected by the operator. In a case where the next button 904 is tapped, the screen transitions to an editing screen 1000 shown in FIG. 10.

FIG. 10 is a diagram showing the editing screen 1000. The editing screen 1000 includes a return button 1006, a page editing region 1001, a text button 1002, an image button 1003, a save button 1004 and a next button 1005. In a case where the return button 1006 is tapped, the display control unit 504 makes the display on the touch-panel display 240 transition to the contents selection screen 700 shown in FIG. 7. In the page editing region 1001, a work (contents data) generated by the editing app using the contents data (template) and image data selected by the operator.

The work (contents data) may include a plurality of pages. For example, in a case where the contents data (template) selected on the contents selection screen 700 allows one image to be arranged in one page, and ten images are selected on the image selection screen 900, a work including ten pages is created. Alternatively, for example, in a case where the template selected on the contents selection screen 700 allows two images to be arranged in one page, and ten images are selected on the image selection screen 900, a work including five pages is created.

In a case where the contents data includes a plurality of pages, the display control unit 504 displays the contents data in the page editing region 1001 on a page basis. Furthermore, the display control unit 504 displays pages by scrolling according to the gesture operation by the operator. For example, in a case of displaying contents data including ten pages, the display control unit 504 first displays a page included in the work in the page editing region 1001 on the editing screen 1000. In a case where the operator wants the subsequent page to be displayed, the operator performs the swipe operation from left to right, for example, on the touch-panel display 240. In a case where the operator wants the previous page to be displayed, the operator performs the swipe operation from right to left, for example, on the touch-panel display 240. Details of the swipe operation for page transition of the contents data in this embodiment will be described later. Note that the direction of the swipe operation may be the up-and-down direction, rather than the left-and-right direction, depending on the page configuration or the method of display control of the editing app.

In a case where the text button 1002 is tapped on the editing screen 1000, the display control unit 504 displays a text input screen (not shown). The editing processing unit 502 generates a text object including a text input by the operator on the text input screen and arranges the text object in the page displayed in the page editing region 1001. Note that the position at which the text object is arranged may be arbitrarily set by the operator or may be previously determined for each template. The position at which the text object is arranged can be changed by the drag operation by the operator, for example.

In a case where the image button 1003 is tapped on the editing screen 1000, the display control unit 504 displays an image selection screen (not shown). On the image selection screen, image data stored in the non-volatile memory 312 of the information processing apparatus 200 and image data stored in the image management server 402 are displayed in a selectable matter. In a case where image data stored in the image management server 402 is selected by the operator, the editing app obtains the selected image data from the image management server 402. In a case where image data stored in the non-volatile memory 312 of the information processing apparatus 200 is selected by the operator, the editing app obtains the selected image data from the non-volatile memory 312. The editing processing unit 502 generates an image object including the image data selected by the operator on the image selection screen and arranges the image object in the page displayed in the page editing region 1001. Note that the position at which the image data is arranged may be arbitrarily set by the operator or may be previously determined for each contents. The position at which the image object is arranged can be changed by the drag operation by the operator, for example.

In a case where editing processing is performed on the displayed page by operation from the operator, the editing processing unit 502 reflects the result of the editing processing in the page displayed in the page editing region 1001. The display control unit 504 updates the display content of the page displayed in the page editing region 1001 so that the display content reflects the editing result, and displays the content. The editing processing on the page includes not only generation, arrangement and deletion of a new text object or a new image object but also modification of the text or image in each object, and change of the position at which the object is arranged, for example. In a case where the save button 1004 is tapped, the editing processing unit 502 saves the data of the contents including the page displayed in the page editing region 1001 in a predetermined save location. The save location may be the non-volatile memory in the information processing apparatus 200 or the contents management server. In a case where the next button 1005 is tapped, the display control unit 504 makes the display on the touch-panel display 240 transition to a confirmation screen for the print setting.

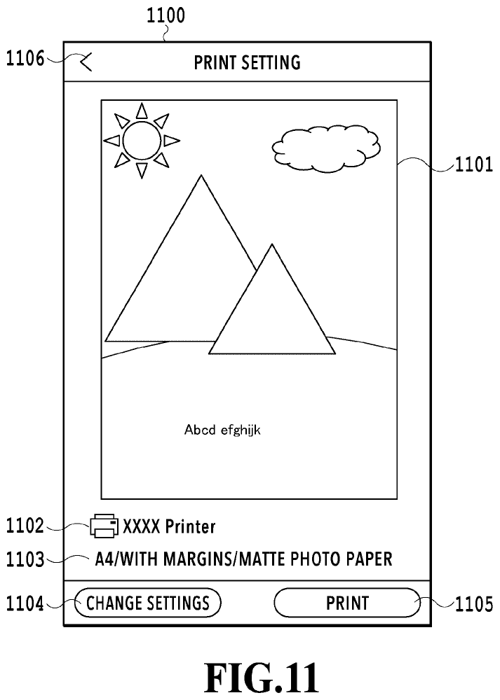

FIG. 11 is a diagram showing a confirmation screen 1100 for the print setting. The confirmation screen 1100 for the print setting includes a return button 1106, a preview display region 1101, a registered printer information region 1102, a print setting display region 1103, a print setting button 1104 and a print button 1105. In a case where the return button 1106 is tapped, the display control unit 504 makes the display on the touch-panel display 240 transition to the screen (the editing screen 1000 shown in FIG. 10) before the transition to this screen. In the preview display region 1101, a print preview image of the contents data edited in the page editing region 1001 is displayed. In a case where the print setting button 1104 is tapped, a print details setting screen (not shown) for changing the printer that is the target of transmission of the print job or the print setting is displayed. On the print details setting screen, the print setting unit 505 receives a print setting from the operator. On the print details setting screen, for example, the printer that is the target of transmission of the print job, the number of prints, the type of the sheet used for printing and the size of the sheet used for printing can be set and changed, for example.

In the registered printer information region 1102, information on the printer currently registered as the target of transmission of the print job is displayed. In the print setting display region 1103, as the print setting currently registered, for example, information on the sheet size, the presence or absence of a margin and the type of the sheet is displayed. In a case where the print setting information is included in the selected contents, the print setting is updated using the print setting information and displayed in the print setting display region 1103. Note that in a case where the printer that is the target of transmission of the print job or the print setting is changed on the print setting screen, and then the screen shown in FIG. 11 is displayed again, the content after the change is displayed in the registered printer information region 11102 and the print setting display region 1103. Furthermore, the content displayed in the registered printer information region 1102 or the print setting display region 1103 is stored in the program memory 213 or the non-volatile memory 212. Therefore, in a case where the editing app is terminated and activated again, the same content is displayed again in the registered printer information region 1102 and the print setting display region 1103. Note that in a case where the confirmation screen 1100 for the print setting is displayed for the first time after the editing app is installed in the information processing apparatus 200, and the selected contents do not include print setting information, a default print setting previously determined is displayed.

In a case where the print button 1105 is tapped, the print setting unit 505 generates, based on the print setting, a print job for printing the contents data selected or edited by the operator and transmits the print job to the printing apparatus 300. Specifically, first, the print setting unit 505 performs rendering on the contents data selected or edited by the operator and converts the contents data into JPEG data. Furthermore, the print setting unit 505 assigns a print control instruction including the print setting information or the like to the generated JPEG data to generate a print job. The print setting unit 505 transmits the print job generated in this way to the printing apparatus 300. Note that while the printing apparatus 300 is performing printing based on the print job after the print job is transmitted thereto, the display control unit 504 may make the display on the touch-panel display 240 transition to a printing screen (not shown). On the printing screen, progress information on the printing based on the print job, the content of the print setting of the transmitted print job, or an operation button for canceling the printing based on the print job is displayed, for example.

### (Operation Receiving Process on Editing Screen)

Next, a flow of a process performed by the information processing apparatus 200 according to this embodiment will be described. FIG. 12 is a flowchart showing a flow of an operation receiving process on the editing screen for the editing app. The process shown in the flowchart of FIG. 12 is started in a case where the editing app is activated in the information processing apparatus 200 and the editing screen shown in FIG. 10 is displayed. Note that the process shown in this flowchart is implemented by the CPU 211 executing a program of the editing app stored in the program memory 213 or the non-volatile memory 212 by loading the program in the data memory 214, which is a RAM. In addition, all the processing shown in FIG. 12 is not necessarily sequentially performed in one process. For example, there may be a case where the responsibility of processing is once transferred to the OS, the OS invokes the editing app again, and then the editing app performs the subsequent processing. Furthermore, the character “S” in the following description means a step number. This holds true for the description of the flowcharts shown in the embodiments described below.

In S1201, the operation receiving unit 503 receives a gesture operation from the operator. In S1202, the operation receiving unit 503 determines whether the gesture operation received in S1201 is a swipe operation. In a case where the gesture operation received in S1201 is not a swipe operation, the process proceeds to S1203. In a case where the gesture operation received in S1201 is a swipe operation, the process proceeds to S1204.

In S1203, the operation receiving unit 503 recognizes the gesture operation received in S1201 as an operation associated with the gesture operation, and issues a notification to the editing processing unit 502. For example, in a case where the gesture operation received in S1201 is a tap operation, the operation receiving unit 503 recognizes the gesture operation as an operation of indicating the object at the operation position. In a case where the gesture operation received in S1201 is a tap and hold operation, the operation receiving unit 503 recognizes the gesture operation as an operation of selecting the object at the operation position.

In S1204, the operation receiving unit 503 determines whether there is an object at the position where the swipe operation is performed. The object that is the target of the determination in this step is an image object, a text object or a graphic object or the like arranged on the page. In a case where it is determined that there is an object at the position where the swipe operation is performed, the operation receiving unit 503 recognizes the swipe operation as a swipe operation (drag operation) for the object, and the process proceeds to S1205.

In S1205, the editing processing unit 502 performs processing of moving the target object. In addition, the display control unit 504 provides a display in which the processing result is reflected. After that, the process proceeds to S1201.

In S1204, in a case where it is determined that there is no object at the position where the swipe operation is performed, the operation receiving unit 503 recognizes the swipe operation as an operation of changing the display page, and the process proceeds to S1206.

In S1206, the display control unit 504 displays the subsequent page on the touch-panel display 240. After that, the process proceeds to S1207.

In S1207, the operation receiving unit 503 receives a gesture operation from the operator in the page newly displayed in S1206.

In S1208, the operation receiving unit 503 determines whether a gesture operation is performed. In a case where it is determined that no gesture operation is performed, the process returns to S1207, in which a gesture operation is waited for. In S1208, in a case where it is determined that a gesture operation is performed, the process proceeds to S1209.

In S1209, the operation receiving unit 503 measures the length of time from the point in time at which the gesture operation (swipe operation) is performed in S1201 to the point in time at which the gesture operation is performed in S1207, and determines whether the length of time is less than a predetermined time (Ts). In the following, the length of time from the point in time at which the swipe operation is performed in S1201 to the point in time at which the gesture operation is performed in S1207 will be referred to as an operation time interval T. Furthermore, the swipe operation in S1201 will be referred to as a first operation, and the gesture operation in S1207 will be referred to as a second operation. The operation time interval T between the first operation and the second operation is defined as the length of time from the point in time at which the first operation is completed (touch-off time) to the point in time at which the second operation is started (touch-on time). The operation receiving unit 503 determines whether the operation time interval T between the first operation and the second operation is less than the predetermined time (Ts).

In S1209, in a case where the operation time interval T between the first operation and the second operation is less than the predetermined time (Ts), the operation receiving unit 503 recognizes the second operation as an operation of changing the display page, regardless of what type of gesture operation the second operation is. That is, the operation receiving unit 503 recognizes the second operation as the first operation. After that, the process proceeds to S1210.

In S1210, the display control unit 504 displays the subsequent page on the touch-panel display 240.

In S1209, in a case where it is determined that the operation time interval T between the first operation and the second operation is equal to or more than the predetermined time (Ts), the operation receiving unit 503 proceeds to S1211.

In S1211, the operation receiving unit 503 determines whether there is an object at the position where the second operation is performed. Note that the object determined in S1211 may be an object arranged in the page, such as an image object, a text object or a graphic object, or an outside object, such as a button displayed in the editing screen 1000 shown in FIG. 10. In the case of the editing screen 1000, the outside objects include the text button 1002, the image button 1003, the save button 1004, the next button 1005 and the return button 1006.

In a case where it is determined that there is no such object at the operation position of the second operation, the operation receiving unit 503 recognizes the second operation as an operation of changing the display page (first operation), regardless of what type of gesture operation the second operation is, and the process proceeds to S1210. In S1210, as described above, the display control unit 504 further displays the subsequent page on the touch-panel display 240. After that, the process of this flowchart ends.

In S1211, in a case where it is determined that there is an object at the position where the second operation is performed, the operation receiving unit 503 proceeds to S1212.

In S1212, the operation receiving unit 503 recognizes the second operation as a gesture operation for the object determined to be present in S1211, and issues a notification to the editing processing unit 502. For example, in a case where the second operation is a tap operation, the operation receiving unit 503 recognizes the second operation as an operation of indicating the object at the operation position. In a case where the second operation is a tap and hold operation, the operation receiving unit 503 recognizes the second operation as an operation of selecting the object at the operation position or a special operation defined in association with the tap and hold operation in advance. In a case where the second operation is a swipe operation, the operation receiving unit 503 recognizes the second operation as an operation (drag operation) of moving the object at the operation position. The editing processing unit 502 performs processing corresponding to the gesture operation on the target object. In a case where the target object is a button, and the second operation is a tap operation, processing associated with the button is performed. After that, the process proceeds to S1207.

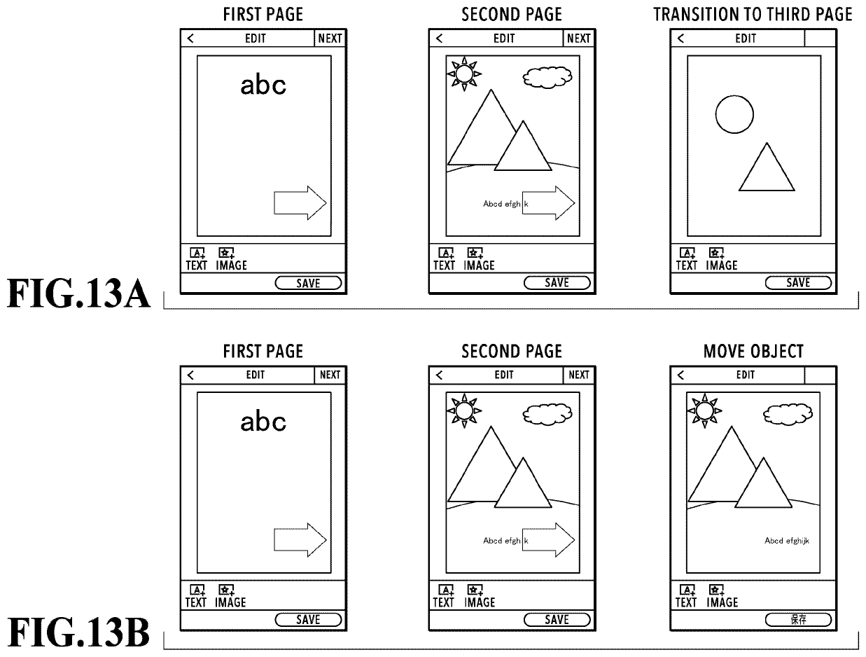

FIG. 13A and FIG. 13B show diagrams showing an example of operations in the flowchart of FIG. 12. FIG. 13A shows diagrams showing operations in a case where it is determined in S1209 that the operation time interval T between the first operation and the second operation is less than the predetermined time (Ts). FIG. 13B shows diagrams showing operations in a case where it is determined in S1209 that the operation time interval T between the first operation and the second operation is equal to or more than the predetermined time (Ts).

The left diagram in FIG. 13A shows a state where a page 1310 included in contents data is displayed on an editing screen 1300. For convenience of description, the page 1310 will be referred to as a first page. It is assumed that in the state where the first page is displayed, a swipe operation 1301 that is a gesture operation of changing the display page is performed. The swipe operation is the first operation described above. In a case where there is no object arranged at the operation position of the swipe operation 1301 on the page 1310, the result of the determination in S1204 is NO, and the subsequent page is displayed by the processing in S1206. A page 1320 in FIG. 13A is a page displayed as the subsequent page to the first page. This page will be referred to as a second page. It is assumed that in the page 1320, which is the second page, a text object 1321 is arranged on an image (that is, arranged in a foreground layer). In a case where some gesture operation 1302 is performed in the state where the second page is displayed, and the operation time interval T between the gesture operation and the first operation is less than the predetermined time Ts, the result of the determination in S1209 is YES. In that case, a page 1330, which is the subsequent page to the second page, is displayed as a third page by the processing in S1210. That is, the gesture operation (second operation) on the second page is recognized as a gesture operation for page transition.

On the other hand, as shown in FIG. 13B, in a case where the gesture operation 1302 (second operation) performed in the state where the page 1320 that is the second page is displayed is performed after the predetermined time Ts or longer time has elapsed since the point in time of operation of the first operation, the result of the determination in S1209 is NO. In that case, in a case where there is the text object 1321 at the operation position of the second operation as shown in the drawing, the second operation is recognized as an operation for the text object 1321 by the processing in S1212. In a case where the second operation is a swipe operation, the second operation is recognized as a moving operation (drag operation) for the object, and as shown in the right diagram in FIG. 13B, the position of the text object 1321 is changed in the page 1320.

As described above, the editing app displays contents data including a plurality of pages on an editing screen on a page basis. On the editing screen, in a case where after a gesture operation (first operation) of changing the display page is received, the next gesture operation (second operation) is received before the predetermined time Ts elapses, the operation receiving unit 503 recognizes the second operation as the first operation. Therefore, the operation receiving unit 503 changes the page displayed on the touch-panel display 240, whether the second operation is the first operation, or whether any object is arranged at the operation position of the second operation. Therefore, the operability in a case of successive page changes are performed can be improved. Furthermore, if the first operation is a swipe operation, which is common as a gesture operation for scrolling the display page on the smartphone, the pages can be scrolled on the editing screen of the editing app in the same way. Furthermore, since the page can be scrolled (changed) by the swipe operation, a page change button for changing pages does not need to be provided in the editing screen. A wide page editing region can be provided on a small screen.

Note that although FIGS. 12 and 13 show an example in which the page scrolling direction is the left-and-right direction, and the swipe operation occurs from left to right, this is not intended to be limiting. The swipe operation may occur from right to left. Furthermore, the operation directions of the first operation and the second operation may be opposite directions. In that case, the page displayed after the second operation is the previous page, rather than the subsequent page. An example process in the case where the operation directions of the first operation and the second operation are opposite directions will be described in detail with regard to the second embodiment. Furthermore, in a case where the page scrolling direction is the up-and-down direction, the gesture operation for changing the display page can be a swipe operation from bottom to top or from top to bottom.

### Second Embodiment

In the first embodiment, the operation receiving unit 503 determines whether the second operation is recognized as the operation (first operation) for changing the display page based on the operation time interval T between the first operation and the second operation. However, the determination condition is not limited to the operation time interval. For example, in a case where the operator wants to successively change pages, the operator performs successive gesture operations (swipe operations). The operation positions in this case are typically substantially the same. Therefore, in a second embodiment, the operation receiving unit 503 determines whether to recognize the second operation as an operation for changing pages not only based on the operation time interval T between the first operation and the second operation but also based on the operation positions of the first operation and the second operation on the touch-panel display.

Note that the system and the apparatus in the second embodiment have the same configuration as those in the first embodiment. Furthermore, the overall configuration of the functionality of the editing app and the configuration of the UI screen are also the same as those in the first embodiment. The second embodiment differs from the first embodiment in processing content of the operation receiving process performed by the operation receiving unit 503 of the editing app. The following description will be primarily focused on differences from the first embodiment. Furthermore, in the following description, the same components as those in the first embodiment will be denoted by the same reference numerals.

In the second embodiment, in a case where the operation receiving unit 503 receives the second operation in the first page displayed in response to the first operation before the predetermined time has elapsed since the first operation, and both the operations are performed within a predetermined range on the touch-panel display, the operation receiving unit 503 recognizes the second operation as the first operation. In other words, in a case where the operation time interval between the first operation and the second operation is short, and the displacement between the operation positions of the first operation and the second operation is small, the operation receiving unit 503 determines that the second operation is an operation for changing pages. Thus, the operation receiving unit 503 recognizes the second operation as an operation (first operation) for changing pages.

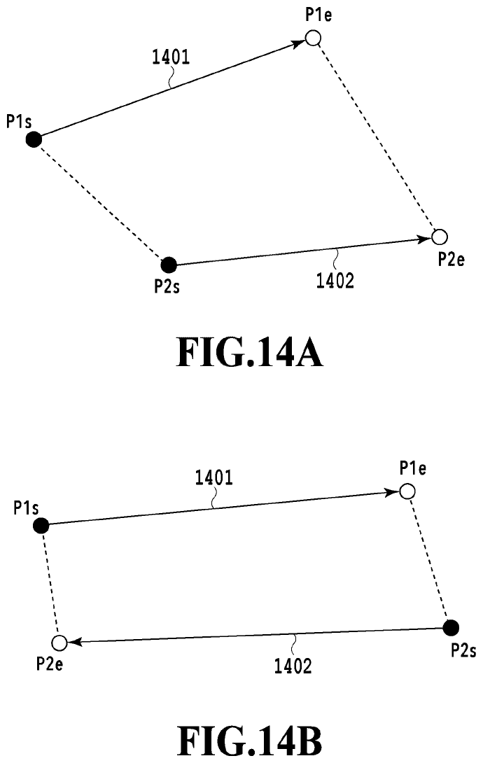

FIG. 14A and FIG. 14B show diagrams for illustrating operation positions of the first operation and the second operation. It is assumed that both the first operation and the second operation are swipe operations. In FIG. 14A, a first vector 1401 represents the first operation, and a second vector 1402 represents the second operation. Furthermore, the starting position (touch-on position) of the first operation is denoted as P1s (X1s, Y1s), the end position (touch-off position) of the first operation is denoted as P1e (X1e, Y1e), the touch-on position of the second operation is denoted as P2s (X2s, Y2s), and the touch-off position of the second operation is denoted as P2e (X2e, Y2e). In a case where successive page transitions are needed, the operation position of the first operation and the operation position of the second operation are substantially the same, and the operation direction are also substantially the same. Therefore, in a case where the operation time interval T between the first operation and the second operation is less than the predetermined time Ts, and the operation positions of the first operation and the second operation are located within a predetermined range, the operation receiving unit 503 recognizes the second operation as an operation (first operation) for changing the display page. Specifically, the operation receiving unit 503 determines, as a displacement amount La between the operation positions, a sum of the distance between the touch-on position Pls of the first operation and the touch-on position P2s of the second operation and the distance between the touch-off position P1e of the first operation and the touch-off position P2e of the second operation. In a case where the displacement amount La between the operation positions is less than a predetermined value Lf, the operation receiving unit 503 determines that the operation positions of the first operation and the second operation are located within the predetermined range. A condition concerning the operation positions is expressed by the following formula (1).

$$L a = \sqrt{{( X 1 s - X 2 s )}^{2} + {( Y 1 s - Y 2 s )}^{2}} + \sqrt{{( X 1 e - X 2 e )}^{2} + {( Y 1 e - Y 2 e )}^{2}} < Lf \qquad ( 1 )$$

Note that FIG. 14A and the formula (1) show operation directions and a determination formula for operation positions, respectively, in a case where the page sequentially transitions from the first page to the second page, from the second page to the third page and so on.

FIG. 14B is a diagram showing operation directions in a case where an operation of changing from the first page to the second page and immediately returning to the first page is performed. In FIG. 14B, a first vector 1401 represents the first operation, and a second vector 1402 represents the second operation. Furthermore, the starting position of the first operation is denoted as Pls, the end position of the first operation is denoted as P1e, the starting position of the second operation is denoted as P2s, and the end position of the second operation is denoted as P2e. In a case where the page needs to be returned in the opposite direction while an operation of sequentially changing pages is performed, the operation directions of the first operation and the second operation are opposite to each other. Therefore, in a case where the operation time interval T between the first operation and the second operation is less than the predetermined time Ts, and the operation positions of the first operation and the second operation are located within a predetermined range, the operation receiving unit 503 recognizes the second operation as an operation (first operation) for changing pages. In this case, the operation receiving unit 503 determines, as a displacement amount Lb between the operation positions, a sum of the distance between the touch-on position Pls of the first operation and the touch-off position P2e of the second operation and the distance between the touch-off position P1e of the first operation and the touch-on position P2s of the second operation. In a case where the displacement amount Lb between the operation positions is less than a predetermined value Lr, the operation receiving unit 503 determines that the operation positions of the first operation and the second operation are located within the predetermined range. A condition concerning the operation positions is expressed by the following formula (2). Note that the predetermined value Lr in the formula (2) may be the same as or different from the predetermined value Lf in the formula (1).

$$L b = \sqrt{{( X 1 s - X 2 e )}^{2} + {( Y 1 s - Y 2 e )}^{2}} + \sqrt{{( X 1 e - X 2 s )}^{2} + {( Y 1 e - Y 2 s )}^{2}} < Lr \qquad ( 2 )$$

### (Operation Receiving Process on Editing Screen)

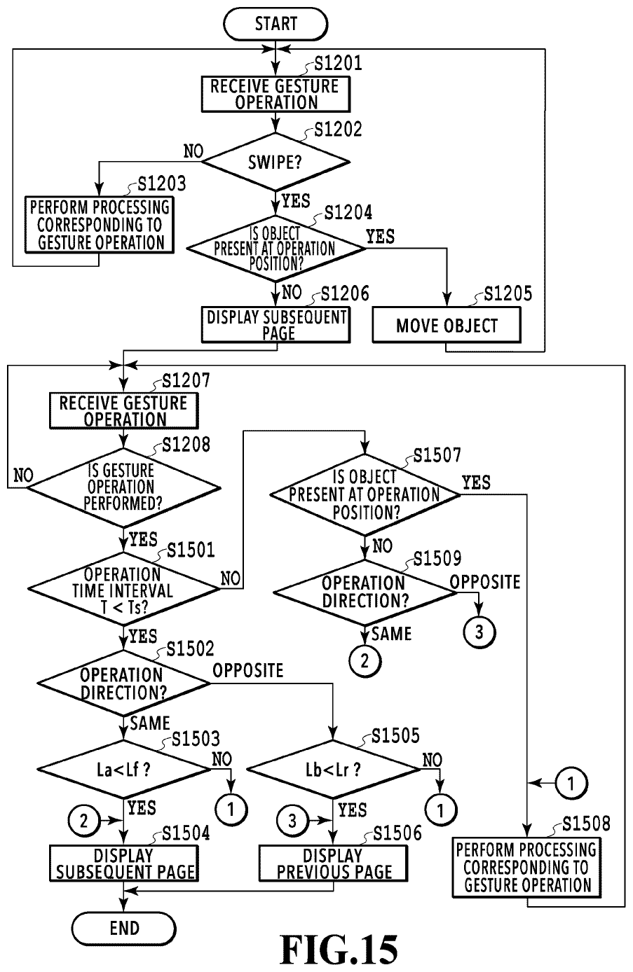

FIG. 15 is a flowchart showing a flow of an operation receiving process on the editing screen according to the second embodiment. The process shown in the flowchart of FIG. 15 is started in a case where the editing app is activated in the information processing apparatus 200 and a page of contents data is displayed on the editing screen shown in FIG. 10. In the flowchart of FIGS. 15, S1201 to S1208 are the same as S1201 to S1208 in FIG. 12. In this flowchart, processing in S1501 to S1509 is added after the determination result is YES in S1208. In the following, different processing from the processing in the first embodiment will be mainly described.

The process until the page transitions to the second page in response to the swipe operation on the first page is the same as that in the first embodiment (S1201 to S1206).

In S1207, the operation receiving unit 503 receives a gesture operation (second operation).

In S1208, in a case where it is determined that a gesture operation (second operation) is performed, the process proceeds to S1501.

In S1501, the operation receiving unit 503 determines whether the operation time interval T from the operation time of the gesture operation (first operation) in S1201 to the operation time of the gesture operation (second operation) in S1207 is less than a predetermined time (Ts). The determination method for the operation time interval T is the same as that in the first embodiment.

In S1501, in a case where the operation time interval T between the first operation and the second operation is less than the predetermined time (Ts), the operation receiving unit 503 proceeds to S1502. In a case where the operation time interval T between the first operation and the second operation is equal to or more than the predetermined time (Ts), the operation receiving unit 503 proceeds to S1507.

In S1502, the operation receiving unit 503 determines the operation direction of the second operation. Specifically, the operation receiving unit 503 determines the angle between the first vector 1401 connecting the touch-on position Pls of the first operation and the touch-off position P1e of the first operation and the second vector 1402 connecting the touch-on position P2s and the touch-off position P2e of the second operation. In a case where the angle between the first vector 1401 and the second vector 1402 is less than a predetermined angle θ1, the operation receiving unit 503 determines that the operation direction of the second operation is the same as the operation direction of the first operation, and proceeds to S1503. In a case where the angle between the first vector 1401 and the second vector 1402 is equal to or more than a predetermined angle θ2, the operation receiving unit 503 determines that the operation direction of the second operation is opposite to the operation direction of the first operation, and proceeds to S1505.

In S1503, the operation receiving unit 503 determines whether the operation positions of the first operation and the second operation are located within a predetermined range based on the formula (1) described above. That is, in a case where the displacement amount La between the operation positions described above is less than a predetermined value Lf, the operation receiving unit 503 determines that the operation positions of the first operation and the second operation are located within a predetermined range, and proceeds to S1504.

In S1504, the display control unit 504 displays the subsequent page on the touch-panel display 240.

In the determination in S1503, in a case where it is determined that the displacement amount La between the operation positions is equal to or more than the predetermined value Lf, the operation receiving unit 503 determines that the operation positions of the first operation and the second operation are not located within the predetermined range, and proceeds to S1508. S1508 will be described later.

In S1505, the operation receiving unit 503 determines whether the operation positions of the first operation and the second operation are located within a predetermined range based on the formula (2) described above. That is, in a case where the displacement amount Lb between the operation positions described above is less than a predetermined value Lr, the operation receiving unit 503 determines that the operation positions of the first operation and the second operation are located within a predetermined range, and proceeds to S1506.

In S1506, the display control unit 504 displays the previous page on the touch-panel display 240.

In the determination in S1505, in a case where the displacement amount Lb between the operation positions is equal to or more than the predetermined value Lr, the operation receiving unit 503 determines that the operation positions of the first operation and the second operation are not located within the predetermined range, and proceeds to S1508. S1508 will be described later.

In S1507, the operation receiving unit 503 determines whether there is an object at the position where the gesture operation (second operation) in S1207 is performed. Note that the object determined in S1507 may be an object arranged in the page or an outside object, such as a button displayed in the editing screen 1000. In a case where it is determined that there is such an object at the operation position of the second operation, the operation receiving unit 503 receives the second operation as it is, and proceeds to S1508.

In S1508, the operation receiving unit 503 recognizes the second operation as a gesture operation for the object determined to be present in S1507, and issues a notification to the editing processing unit 502. For example, in a case where the second operation is a tap operation, the operation receiving unit 503 recognizes the second operation as an operation of indicating the object at the operation position. In a case where the second operation is a tap and hold operation, the operation receiving unit 503 recognizes the second operation as an operation of selecting the object at the operation position. In a case where the second operation is a swipe operation, the operation receiving unit 503 recognizes the second operation as an operation (drag operation) of moving the object at the operation position. The editing processing unit 502 performs processing corresponding to the gesture operation on the target object. In a case where the target object is a button, and the second operation is a tap operation, processing associated with the button is performed. After that, the process proceeds to S1207.

In S1507, in a case where it is determined that there is no object at the operation position of the second operation, the operation receiving unit 503 proceeds to S1509.

In S1509, the operation receiving unit 503 determines the operation direction of the second operation. The determination of the operation direction is the same as the determination method in S1502. In S1509, in a case where it is determined that the operation direction of the second operation is the same as the operation direction of the first operation, the process proceeds to S1504, and the display control unit 504 displays the subsequent page on the touch-panel display 240. In S1509, in a case where it is determined that the operation direction of the second operation is opposite to the operation direction of the first operation, the process proceeds to S1506, and the display control unit 504 displays the previous page on the touch-panel display 240. In a case where the processing in S1504 or S1506 ends, this flowchart ends.

Note that although both the horizontal position (X coordinate) and the vertical position (Y coordinate) are considered in the determination of the operation positions described above as shown by the formulas (1) and (2), this is not intended to be limiting. Whether the operation positions are located within a predetermined range may be determined based on any one of the horizontal direction and the vertical direction. For example, in a case of where control is performed so that the page transitions to the subsequent page or the previous page by a swipe operation in the left-and-right direction, the operation receiving unit 503 can determine the displacement amount between the first operation and the second operation based on the horizontal positions of the first operation and the second operation and determine whether the displacement amount is less than a predetermined distance. In that case, a displacement amount Lc between the operation positions of the first operation and the second operation in a case where the operation direction of the first operation and the operation direction of the second operation are the same is determined according to the following formula (3). A displacement amount Ld between the operation positions in a case where the operation directions of the first operation and the second operation are opposite to each other is determined according to the following formula (4).

$$Lc = \vert X 1 s - X 2 s \vert + \vert X 1 e - X 2 e \vert \qquad ( 3 )$$

$$Ld = \vert X 1 s - X 2 e \vert + \vert X 1 e - X 2 s \vert \qquad ( 4 )$$

Furthermore, in a case where control is performed so that the page transitions to the subsequent page or the previous page by a swipe operation in the up-and-down direction, the operation receiving unit 503 can determine the displacement amount between the first operation and the second operation based on the vertical positions of the first operation and the second operation and determine whether the displacement amount is less than a predetermined distance. In that case, a displacement amount Le between the operation positions of the first operation and the second operation in a case where the operation directions of the first operation and the second operation are the same is determined according to the following formula (5). A displacement amount Lg between the operation positions in a case where the operation directions of the first operation and the second operation are opposite to each other is determined according to the following formula (6).

$$Le = \vert Y 1 s - Y 2 s \vert + \vert Y 1 e - Y 2 e \vert \qquad ( 5 )$$

$$Lg = \vert Y 1 s - Y 2 e \vert + \vert Y 1 e - Y 2 s \vert \qquad ( 6 )$$

Note that although the displacement amounts of both the touch-on positions and the touch-off positions of the first operation and the second operation are determined in the determination of the displacement amount between the operation positions in S1503 and S1505, this is not intended to be limiting. For example, the displacement amount between the touch-on positions may be determined as the displacement amount between the operation positions. Alternatively, the displacement amount between the touch-off positions may be determined as the displacement amount between the operation positions.

As described above, in the second embodiment, the operation receiving unit 503 determines not only the operation time interval between the first operation and the second operation but also whether the operation positions of the first operation and the second operation are located within a predetermined range. In a case where the operation positions of the first operation and the second operation are located within a predetermined range, that is, in a case where the displacement amount between the operation positions is less than a predetermined value, the operation receiving unit 503 recognizes the second operation as the first operation. That is, in a case where the second operation is performed at substantially the same position in a short time after the first operation, the display control unit 504 changes the page displayed, regardless of whether the second operation is the first operation or whether there is an object arranged at the operation position of the second operation. On the other hand, even in a case where the subsequent gesture operation (second operation) is received before the predetermined time Ts has elapsed since the first operation, if the operation position of the second operation is distant from the operation position of the first operation, the operation receiving unit 503 does not recognize the second operation as the first operation (operation of changing pages). Therefore, in a case where the operator performs successive gesture operations, processing matching the intention of the operator can be performed, and the operability can be improved.

### Third Embodiment

In the first embodiment, an operation event of the second operation is determined based on the operation time interval between the first operation and the second operation. In the second embodiment, an operation event of the second operation is determined based on the operation time interval between the first operation and the second operation and the displacement amount between the operation positions of the first operation and the second operation. However, in some cases, the operability improves in a case where such control is not performed. In view of this, in a third embodiment, a case will be described in which the second operation is a particular exception operation previously set, and an object that can be operated by the exception operation is arranged at the operation position of the second operation. In this case, even in a case where the operation time interval between the first operation and the second operation is less than the predetermined time Ts, the operation receiving unit 503 does not recognize the second operation as an operation of displaying the subsequent (or previous) page, and performs control to perform processing according to the second operation and the operation target. That is, in a case where the second operation is a particular exception operation for an object, the second operation is excepted from the control according to the first embodiment or second embodiment.

For example, the particular exception operation is a tap operation for an object. The object in the determination of the particular exception operation is the same as the object in the determination in S1211. Specifically, the object may be an object arranged in the page, such as an image object, a text object or a graphic object, or an outside object, such as a button displayed in the editing screen 1000 shown in FIG. 10.

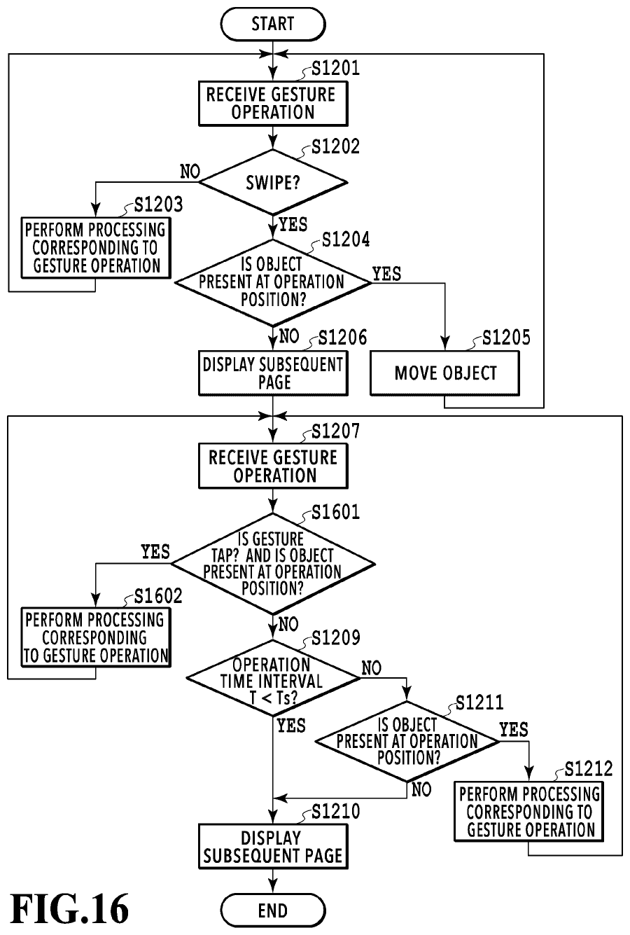

FIG. 16 is a flowchart showing a flow of an operation receiving process on the editing screen according to the third embodiment. The process shown in the flowchart of FIG. 16 is started in a case where the editing app is activated in the information processing apparatus 200 and the editing screen shown in FIG. 10 is displayed. In the flowchart of FIG. 16, processing in S1201 to S1207 and S1209 to S1212 is the same as the processing in S1201 to S1207 and S1209 to S1212 in FIG. 12. In this flowchart, processing in S1601 to S1602 is added after S1207. In the following, different processing from the processing in the first embodiment will be mainly described.

The process until the page transitions to the second page in response to the swipe operation on the first page is the same as that in the first embodiment (S1201 to S1206).

In S1207, the operation receiving unit 503 receives a gesture operation (second operation). After that, the process proceeds to S1601.

In S1601, the operation receiving unit 503 determines whether the gesture operation (second operation) received in S1207 is the particular exception operation. That is, the operation receiving unit 503 determines whether the gesture operation received in S1207 is a tap operation and there is an object at the operation position. In a case where it is determined that the gesture operation received in S1207 is a tap operation and there is an object at the operation position, the process proceeds to S1602. In a case where the gesture operation (second operation) received in S1207 is not a tap operation or there is no object at the operation position, the operation receiving unit 503 determines that the gesture operation is not the particular exception operation and proceeds to S1209.

In S1602, the operation receiving unit 503 recognizes the tap operation that is the second operation as a tap operation for the object determined to be present in S1601, and issues a notification to the editing processing unit 502. For example, in a case where the object is an object arranged in the page, the operation receiving unit 503 recognizes the tap operation that is the second operation as an operation of specifying the object. In a case where the object is a button arranged outside the page, the operation receiving unit 503 recognizes the tap operation that is the second operation as an operation of pressing the button, and the editing processing unit 502 performs processing associated with the button. After that, the process proceeds to S1207. The processing in S1209 and the following steps is the same as that in FIG. 12.

Note that although the flowchart of FIG. 16 illustrates a case where a particular exception operation is received in the process shown in the flowchart of FIG. 12 according to the first embodiment described above, the particular exception operation can also be received in the process shown in FIG. 15 according to the second embodiment described above. In that case, S1208 in FIG. 15 can be replaced with S1601 to S1602. In a case where the determination result in S1601 is YES, the process proceeds to S1501.

In the third embodiment, as described above, in the process according to the first embodiment or second embodiment, it is determined whether the subsequent gesture operation (second operation) received before the predetermined time Ts elapses after the gesture operation (first operation) of changing pages is received is a particular exception operation. In a case where the second operation is the particular exception operation, page change is not performed, and processing corresponding to the gesture operation (second operation) is performed. In this way, successive page changing operations and an operation other than the page changing operation can be received in a distinguishable manner, and the operability in displaying contents data including a plurality of pages can be improved.

Note that the operator may be able to set whether the particular exception operation is valid or invalid. In a case where the particular exception operation is valid, the operator may be able to further set which gesture operation the particular exception operation is. The particular exception operation is not limited to one type of operation, and there may be a plurality of types of particular exception operations.

Although preferred embodiments of the present disclosure have been described with reference to the accompanying drawings, the present disclosure is not limited to these embodiments. For example, the displayed content, the way of display and the arranged buttons on each screen, the functions that can be performed on each screen and the like are examples. Obviously, various variations or modifications within the scope of the disclosed technical concept can occur to those skilled in the art, and of course, those variations or modifications are included in the technical scope of the present disclosure.

The present disclosure is also implemented by supplying a storage medium storing a program code of software that implements the functions according to the embodiments described above to a system or an apparatus and making a computer in the system or apparatus execute the program code stored in the storage medium. In that case, the program code itself read from the storage medium implements the functions according to the embodiments described above, and the storage medium storing the program code is a part of the present disclosure. As the storage medium for supplying the program code, a flexible disk, a hard disk, an optical disk, a magnetooptical disk, a CD-ROM, a CD-R, a magnetic tape, a non-volatile memory card, a ROM, a DVD or the like can be used.

The present disclosure can also be implemented by processing in which a program that implements one or more functions according to the embodiments described above is supplied to a system or an apparatus via a network or a storage medium and one or more processors of a computer in the system or apparatus read and execute the program. Furthermore, the present disclosure can also be implemented by a circuit (an ASIC, for example) that implements one or more functions.

According to the present disclosure, the usability of an information processing apparatus that receives a user operation on a touch-panel display can be improved.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-045355, filed Mar. 19, 2025, which is hereby incorporated by reference herein in its entirety.

What is claimed is:

1. An information processing apparatus comprising:
one or more processors; and
one or more memories storing instructions to cause the one or more processors to function as:
a receiving unit configured to receive a gesture operation of an operator on a touch-panel display; and
a display control unit configured to display data of contents including a plurality of pages on the touch-panel display on a page basis,
wherein an object capable of being moved by a gesture operation is capable of being arranged on a page, and
in a case where after the receiving unit receives a first operation of indicating to change a display page, a second operation that is a subsequent gesture operation is received in a first page that is a display page displayed based on the first operation before a predetermined time elapses since the first operation, the receiving unit recognizes the second operation as the first operation.

2. The information processing apparatus according to claim 1,
wherein in a case where after the receiving unit receives the first operation, the second operation is received in the first page before the predetermined time elapses since the first operation, and the first operation and the second operation are performed within a predetermined range on the touch-panel display, the receiving unit recognizes the second operation as the first operation.

3. The information processing apparatus according to claim 2,
wherein the receiving unit determines whether the first operation and the second operation are performed within the predetermined range on the touch-panel display by determining whether at least one of a displacement amount in a horizontal direction and a displacement amount in a vertical direction between the first operation and the second operation is located within a predetermined range on the touch-panel display.

4. The information processing apparatus according to claim 1,
wherein the first operation is a swipe operation.

5. The information processing apparatus according to claim 4,
wherein the second operation is a swipe operation on the object arranged in the page displayed on the touch-panel display, and
in a case where after the receiving unit receives the first operation, the second operation is received in the first page after the predetermined time elapses since the first operation, the receiving unit recognizes the second operation as an operation of moving the object.

6. The information processing apparatus according to claim 1,
wherein the second operation is a gesture operation on the object arranged in the page displayed on the touch-panel display or an outside object displayed outside of the page, and
in a case where after the receiving unit receives the first operation, the second operation is received in the first page after the predetermined time elapses since the first operation, the receiving unit recognizes the second operation as an operation of processing the object or the outside object.

7. The information processing apparatus according to claim 1,
wherein in a case where the second operation is a particular exception operation previously set, and an object capable of being operated by the particular exception operation is arranged at an operation position of the second operation, even if after the first operation is received, the second operation is performed in the first page before the predetermined time elapses since the first operation, the receiving unit does not recognize the second operation as the first operation but recognizes the second operation as the particular exception operation.

8. The information processing apparatus according to claim 7,
wherein the particular exception operation is a tap operation on the object arranged in the page displayed on the touch-panel display or an outside object displayed outside the page.

9. The information processing apparatus according to claim 1,
wherein in a case where the receiving unit recognizes the second operation as the first operation in the first page,
the display control unit changes the display page displayed on the touch-panel display from the first page to a second page that is different from the first page.

10. The information processing apparatus according to claim 9,
wherein in a case where an angle between an operation direction of the first operation and an operation direction of the second operation is less than or equal to a predetermined first angle, the display control unit displays a page subsequent to the first page as the second page, and
in a case where the angle between the operation direction of the first operation and the operation direction of the second operation is more than a predetermined second angle, the display control unit displays a page preceding the first page as the second page.

11. The information processing apparatus according to claim 4,
wherein in a case where the receiving unit receives the first operation, the display control unit changes the display page by moving the display page in a left-and-right direction.

12. The information processing apparatus according to claim 4,
wherein in a case where the receiving unit receives the first operation, the display control unit changes the display page by moving the display page in a up-and-down direction.

13. The information processing apparatus according to claim 1, further comprising:
an editing processing unit configured to perform editing processing on the data of the contents,
wherein the display control unit displays a screen for receiving an operation for the data of the contents from the operator on the touch-panel display as a user interface screen of the editing processing unit,
the plurality of pages included in the data of the contents are displayed on the user interface screen on a page basis, and
the first operation and the second operation are gesture operations on the user interface screen.

14. A method executed by an information processing apparatus comprising:
receiving a gesture operation of an operator on a touch-panel display; and
displaying data of contents including a plurality of pages on the touch-panel display on a page basis,
wherein an object capable of being moved by a gesture operation is capable of being arranged on a page, and
in receiving a gesture operation, in a case where after a first operation of indicating to change a display page is received, a second operation that is a subsequent gesture operation is received in a first page that is a display page displayed based on the first operation before a predetermined time elapses since the first operation, the second operation is recognized as the first operation.

15. A non-transitory computer readable storage medium storing a program which causes a computer to execute an information processing method,
wherein an information processing method comprising:
receiving a gesture operation of an operator on a touch-panel display; and
displaying data of contents including a plurality of pages on the touch-panel display on a page basis,
wherein an object capable of being moved by a gesture operation is capable of being arranged on a page, and
in receiving the gesture operation in a case where a first operation of indicating to change a display page is received, a second operation that is a subsequent gesture operation is received in a first page that is a display page displayed based on the first operation before a predetermined time elapses since the first operation, the second operation is recognized as the first operation.
